(19) United States
(12) Patent Application Publication
(10) Pub. No.: US 2021/0201570 A1
(43) Pub. Date: Jul. 1, 2021

(54) METHOD AND APPARATUS FOR GENERATING DIGITAL SURFACE MODEL USING SATELLITE IMAGERY

(71) Applicant: ELECTRONICS AND TELECOMMUNICATIONS RESEARCH INSTITUTE, Daejeon (KR)

(72) Inventors: Jung-Jae YU, Daejeon (KR); Kyung-Kyu KANG, Daejeon (KR); Hye-Sun KIM, Daejeon (KR); Chang-Joon PARK, Daejeon (KR); Yun-Ji BAN, Daejeon (KR); Dong-Wan RYOO, Daejeon (KR); Man-Hee LEE, Daejeon (KR); Chang-Woo CHU, Daejeon (KR)

(21) Appl. No.: 17/133,807

(22) Filed: Dec. 24, 2020

(30) Foreign Application Priority Data
Dec. 26, 2019 (KR) 10-2019-0175224

(51) Int. Cl. G06T 17/05; G06T 7/593; G06T 5/00

(52) U.S. Cl. CPC G06T 17/05; G06T 7/593; G06T 5/006; G06T 2207/20028; G06T 2207/10032; G06T 2207/20072; G06T 2207/20021; G06T 5/002

(57) ABSTRACT

Disclosed herein are a method and apparatus for generating a digital surface model using satellite imagery. The method includes correcting a geometric error in input satellite images, generating one or more depth maps using a stereo matching method based on the corrected satellite images, and generating a digital surface model by combining the generated depth maps and by estimating a height value for each location on the ground surface.

### CROSS REFERENCE TO RELATED APPLICATION

This application claims the benefit of Korean Patent Application No. 10-2019-0175224, filed Dec. 26, 2019, which is hereby incorporated by reference in its entirety into this application.

### BACKGROUND OF THE INVENTION

### 1. Technical Field

The present invention relates generally to a method and apparatus for generating a digital surface model using satellite images, and more particularly to technology for receiving optical satellite images and estimating a height of a ground surface through image processing, thereby generating a Digital Surface Model (DSM).

### 2. Description of Related Art

Unless otherwise indicated herein, the materials described in this section are not prior art with regard to the claims in this application, and are not admitted to be prior art by inclusion in this section.

Generally, a Digital Elevation Model (DEM) is configured to represent only the elevation of terrain at each location in a grid after removing aboveground objects, such as buildings, whereas a Digital Surface Model (DSM) represents an elevation, including aboveground objects, such as buildings, at each location on the surface of the earth.

A DEM and a DSM may be generated using depth information acquired using a device such as LiDAR, or may be generated by estimating depth information based on photogrammetry, which uses aerial images, optical satellite images, and the like as input.

A conventional method for generating a DSM from optical satellite images is a method using stereo satellite images that are captured in a manner that takes into consideration stereo matching. Depth information may be estimated by performing stereo matching on the input stereo satellite images, and these estimated depth values are converted into values in a spatial coordinate system and postprocessed, whereby a digital surface model may be generated.

When a plurality of stereo satellite images is received for the same area, after the satellite images are grouped into pairs, depth maps are generated using the respective pairs of stereo satellite images, and the depth maps are combined in a spatial coordinate system, whereby a digital surface model (DSM) may be generated.

However, there are problems in that it is expensive to capture stereo satellite images and in that the number of stereo satellite images stored in an archive DB, in which previous satellite images are accumulated, is much smaller than the number of mono images. Therefore, what is required is technology for generating a digital surface model from mono satellite images, which are independently captured for the same area, rather than from stereo satellite images.

### DOCUMENTS OF RELATED ART

(Patent Document 1) Korean Patent No. 10-1006729, registered on Dec. 31, 2010 and titled “Method and system for generating digital elevation model”.

### SUMMARY OF THE INVENTION

An object of the present invention is to generate a digital surface model by receiving mono satellite images.

Another object of the present invention is to reduce noise components using the characteristics of a space and to provide a method for effectively processing a hole area for which no spatial information is present.

The technical objects of the present invention are not limited to the above technical objects, and other technical objects that are not mentioned will be readily understood from the following description.

In order to accomplish the above objects, a method for generating a digital surface model using satellite imagery according to an embodiment of the present invention includes correcting a geometric error in input satellite images, generating one or more depth maps using a stereo matching method based on the satellite images, the geometric error of which is corrected, combining the generated depth maps, estimating a height for each location on a ground surface, and generating a digital surface model.

Here, the satellite images may include geometric or optical information pertaining to a camera that is used to capture the satellite images, the geometric or optical information being stored as Rational Polynomial Coefficients (RPC).

Here, correcting the geometric error may be configured to correct the geometric error using at least one of a method of comparing the satellite images with Ground Control Point (GCP) data and a method of comparing the satellite images with orthogonal projection data of a Digital Elevation Model (DEM).

Here, generating the depth maps may include resampling epipolar lines of the satellite images by converting the epipolar lines in units of pixels such that the epipolar lines become straight lines; arranging the satellite images to be grouped in pairs; and generating the depth maps using the stereo matching method based on the arranged satellite images.

Here, generating the digital surface model may include generating a 3D point cloud based on the depth maps; removing noise from the 3D point cloud; generating initial values for the digital surface model based on the 3D point cloud from which the noise is removed; and compensating a hole area in which the 3D point cloud is not included.

Here, generating the 3D point cloud may include converting depth values of respective pixels in each of the depth maps into 3D points in a geodetic coordinate system; and generating the 3D point cloud by combining the 3D points.

Here, removing the noise may include dividing a space of the 3D point cloud into regularly spaced 3D voxel areas; calculating the number of 3D points included in each of the 3D voxel areas; determining a 3D voxel area to be a valid area when the number of 3D points included therein is equal to or greater than a preset reference number or determining the 3D voxel area to be noise when the number of 3D points included therein is less than the preset reference number; and removing the 3D points included in the 3D voxel area determined to be the noise.

Here, the method may further include calculating a height histogram based on the 3D point cloud; setting a height having the maximum density in the height histogram as a reference height; and setting a height range within a preset constant range from the reference height as a ground surface height area.

Here, determining the 3D voxel area may be configured to determine a 3D voxel area including a number of 3D points equal to or greater than the preset reference number while being included in the ground surface height area to be a valid area and to then sequentially determine 3D voxel areas adjacent to the valid area.

Here, compensating the hole area may include dividing a ground surface in which the 3D point cloud is present into 2D grid cells; grouping the 2D grid cells into upper-level blocks such that each of the upper-level blocks includes two or more 2D grid cells; calculating a lowest height based on 2D grid cells having a valid height in each of the upper-level blocks; estimating a ground surface height of an adjacent area based on the lowest height of each of the upper-level blocks; and storing the ground surface height estimated near the hole area as a height of the hole area in the digital surface model.

Here, compensating the hole area may further include performing noise filtering including at least one of bilateral filtering and a smoothing process.

Also, in order to accomplish the above objects, an apparatus for generating a digital surface model using satellite imagery according to an embodiment of the present invention includes one or more processors and executable memory for storing at least one program executed by the one or more processors. The at least one program may be configured to correct a geometric error in input satellite images, to generate one or more depth maps using a stereo matching method based on the satellite images, the geometric error of which is corrected, to combine the generated depth maps, to estimate a height for each location on a ground surface, and to generate a digital surface model.

Here, the satellite images may include geometric or optical information pertaining to a camera that is used to capture the satellite images, the geometric or optical information being stored as Rational Polynomial Coefficients (RPC).

Here, the at least one program may be configured to correct the geometric error using at least one of a method of comparing the satellite images with Ground Control Point (GCP) data and a method of comparing the satellite images with orthogonal projection data of a Digital Elevation Model (DEM).

Here, the at least one program may be configured to resample epipolar lines of the satellite images by converting the epipolar lines in units of pixels such that the epipolar lines become straight lines, to arrange the satellite images to be grouped in pairs, and to generate the depth maps using the stereo matching method based on the arranged satellite images.

Here, the at least one program may be configured to generate a 3D point cloud based on the depth maps, to remove noise from the 3D point cloud, to generate initial values for the digital surface model based on the 3D point cloud from which the noise is removed, and to compensate a hole area in which the 3D point cloud is not included.

Here, the at least one program may be configured to convert depth values of respective pixels in each of the depth maps into 3D points in a geodetic coordinate system and to generate the 3D point cloud by combining the 3D points.

Here, the at least one program may be configured to remove the noise by dividing a space of the 3D point cloud into regularly spaced 3D voxel areas, calculating the number of 3D points included in each of the 3D voxel areas, determining a 3D voxel area to be a valid area when the number of 3D points included therein is equal to or greater than a preset reference number, determining the 3D voxel area to be noise when the number of 3D points included therein is less than the preset reference number, and removing the 3D points included in the 3D voxel area determined to be the noise.

Here, the at least one program may be configured to calculate a height histogram based on the 3D point cloud, to set a height having the maximum density in the height histogram as a reference height, to set a height range within a preset constant range from the reference height as a ground surface height area, to determine a 3D voxel area including a number of 3D points equal to or greater than the preset reference number while being included in the ground surface height area to be a valid area, and to sequentially determine whether a 3D voxel area is a valid area from a 3D voxel area adjacent to the valid area.

Here, the at least one program may be configured to compensate the hole area by dividing a ground surface in which the 3D point cloud is present into 2D grid cells, grouping the 2D grid cells into upper-level blocks such that each of the upper-level blocks includes two or more 2D grid cells, calculating a lowest height based on 2D grid cells having a valid height in each of the upper-level blocks, estimating a ground surface height of an adjacent area based on the lowest height of each of the upper-level blocks, and storing the ground surface height estimated near the hole area as a height of the hole area in the digital surface model.

Here, the hole area may be compensated after noise filtering, including at least one of bilateral filtering and a smoothing process, is performed.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a flowchart of a method for generating a digital surface model (DSM) using satellite imagery according to an embodiment of the present invention;

FIG. 2 is a flowchart illustrating generation of a depth map according to an embodiment of the present invention;

FIG. 3 is a flowchart illustrating generation of a digital surface model according to an embodiment of the present invention;

FIG. 4 is a flowchart illustrating removal of noise according to an embodiment of the present invention;

FIGS. 5A to 5C are exemplary views illustrating removal of noise according to an embodiment of the present invention;

FIG. 6 is a flowchart illustrating compensation of a hole area according to an embodiment of the present invention;

FIG. 7 is a concept diagram of the process of filling a hole area according to an embodiment of the present invention;

FIGS. 8A to 8C are comparison views illustrating noise removal and hole-filling according to an embodiment of the present invention; and

FIG. 9 is a view illustrating a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations that have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

The present invention proposes a method and apparatus for generating terrain elevation information including aboveground objects, such as a Digital Surface Model (DSM), by receiving optical satellite images as input.

Also, the present invention proposes a method and apparatus for generating a DSM using mono satellite images, rather than stereo satellite images.

Methods for generating a DSM using one or more mono satellite images may be broadly divided into two methods.

The first method is a Probabilistic Volumetric Reconstruction (PVR) method, which calculates the probability that each of voxels segmented from a 3D volume space is a surface area.

The PVR method estimates 3D surface data that is suitable for satellite images input from a single 3D space based on the probability.

The advantage of the PVR method is that it is flexibly modified and used for various purposes, such as change detection, because the PVR method is based on a consistent probability-based framework applicable to all input images.

The second method is a Multi-view Stereo Reconstruction (MSR) method, which divides a plurality of satellite images into pairs, performs stereo resampling on the pairs, generates depth maps in a manner similar to stereo satellite image processing, and combines the depth maps, thereby generating a digital surface model.

In the MSR method, the method of generating each depth map from a pair of satellite images is important, and there is a research result saying that the Semi-Global Matching (SGM) method is superior to other methods as a method of matching satellite images.

When a single height for each set of coordinates is estimated by receiving a plurality of depth maps, a method of converting the depth map information into a 3D point cloud and selecting a median height is commonly used.

In the situation where images captured at different times are input, a method of applying K-means clustering has been proposed in order to solve a problem of multi-modality, but the method has the problem of a high computational load because clustering has to be performed for all sets of coordinates.

There is a research result saying that the MSR method is superior to the PVR method in terms of the accuracy of a digital surface model generated therethrough.

However, mono images capturing the same area at different times in different seasons include changes in surface texture according to spatiotemporal variation and the changing seasons. In this case, when depth maps are calculated using the mono images grouped in pairs, a number of noise components is generated. Accordingly, in order to generate a high-quality digital surface model through which the detailed shapes of aboveground objects can be identified, technology capable of effectively removing such noise components, that is, noise-filtering technology, is required.

Also, in an area crowded with high-rise buildings, such as a downtown area, depth information may not be correctly extracted due to roads between buildings, obstruction of a view (occlusion) in areas such as alleys, the effect of dark shadows, or the like.

Particularly, when the above-mentioned noise filtering is performed, incorrect depth values in such areas are deleted because they are regarded as noise, whereby a hole area, for which no depth value is present, is formed.

When a hole area is present, if the height thereof is filled using an interpolation method, a problem in which the boundary of the appearance of a building is transformed may be caused. Therefore, a method for automatically processing such a hole area will be proposed through an embodiment of the present invention.

Hereinafter, a preferred embodiment of the present invention will be described in detail with reference to the accompanying drawings.

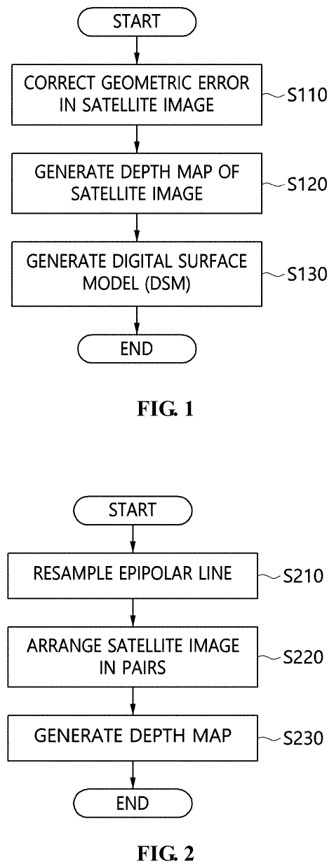

FIG. 1 is a flowchart of a method for generating a digital surface model using satellite imagery according to an embodiment of the present invention.

Referring to FIG. 1, in the method for generating a Digital Surface Model (DSM) using satellite imagery according to an embodiment of the present invention, the course from input of satellite images to completion of generation of a DSM may be divided into the following three steps in order to apply noise removal and hole-filling when a DSM is generated.

The following embodiment is an example of the overall DSM generation process for applying the proposed method. Also, the following embodiment is a method capable of generating depth maps from mono multi-view satellite images and generating a DSM by combining the depth maps, and may be applied similarly to the above-described MSR method.

The first step is a geometric correction step (S110), that is, a step of correcting geometric errors in input satellite images.

The satellite images may store geometric or optical information pertaining to a camera therein as Rational Polynomial Coefficients (RPC) when the satellite images are captured, and the RPC may be the result of digitizing the physical model of a satellite as 80 coefficients in order to make it easy to comprehend the same from the aspect of images.

However, depending on the satellite used to capture the satellite images, an error ranging from a few to tens of meters based on the ground surface may be caused, and a process for correcting such an error is required.

Such an error may be corrected by comparing the input images with Ground Control Point (GCP) information or by comparing the input images with orthogonal projection data of an existing Digital Elevation Model (DEM).

The second step is a step (S120) of grouping the satellite images, the errors of which are corrected, in pairs, arranging the respective pairs of satellite images, and generating depth maps using a stereo matching method. This step will be described in detail with reference to FIG. 2.

The third step is a step (S130) of combining and optimizing the depth maps acquired from the respective pairs of the images, estimating a height for each location on the ground surface, and thereby generating a digital surface model.

Depth maps must have the same height for the same ground surface in theory, but may in practice include incorrect heights due to different capture times and noise components in the images.

Therefore, it is necessary to smooth the shape of a digital surface model by removing the above-described noise components and to accumulate and combine depth information such that the shapes of aboveground objects can be identified.

FIG. 2 is a flowchart illustrating the generation of a depth map according to an embodiment of the present invention.

Describing this process with reference to FIG. 2, unlike in frame camera images, the epipolar lines between satellite images are calculated as curves, rather than as straight lines.

Because epipolar lines are required to take the form of straight lines for stereo matching, a resampling process for converting the locations of the epipolar lines of the satellite images in units of pixels such that the epipolar lines become straight lines may be performed at step S210 when the step of generating depth maps is performed.

Also, at the step of generating depth maps, the satellite images are arranged by grouping the same in pairs at step S220, and depth maps may be generated at step S230 using a stereo matching method based on the satellite images arranged in pairs.

The method of generating the depth maps may be a Semi-Global Matching (SGM) method.

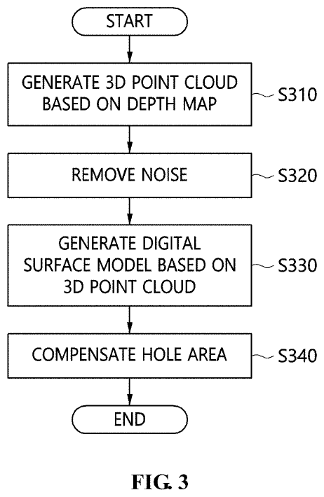

FIG. 3 is a flowchart illustrating generation of a digital surface model according to an embodiment of the present invention.

Referring to FIG. 3, the step of generating a digital surface model may be broadly divided into four steps, and the proposed noise removal and hole-filling are included in these steps.

At the first step for generating a digital surface model, depth values in each depth map image may be converted into a 3D point cloud form in a 3D space at step S310.

This is configured such that, using the RPC information of the satellite image, which is used as input when each depth map image is generated, the depth values of the respective pixels in the depth map image are converted into 3D points in a geodetic coordinate system, such as a Universal Transverse Mercator (UTM) coordinate system.

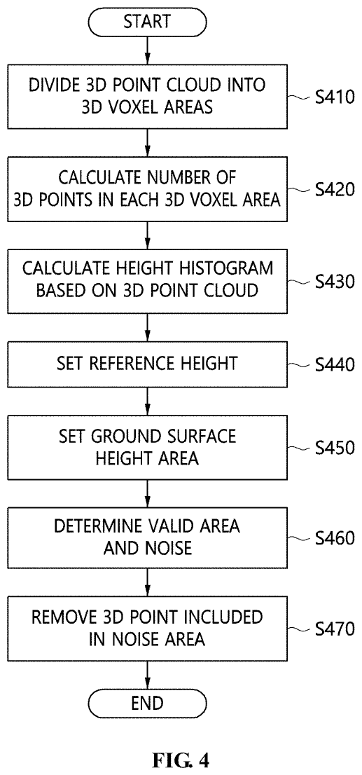

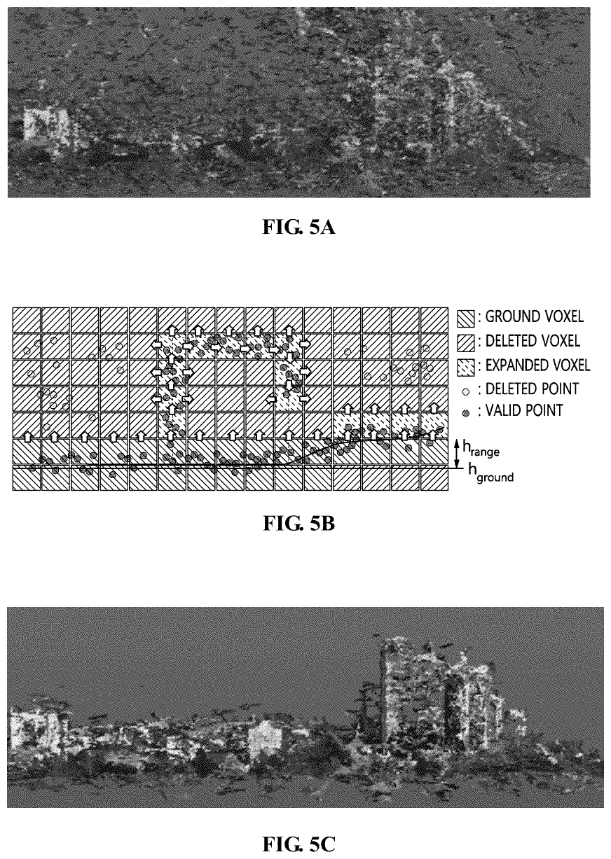

The second step for generating a digital surface model is the step (S320) of filtering noise based on spatial characteristics, and the process of removing noise may be performed. This step will be described in more detail with reference to FIG. 4 and FIGS. 5A to 5C.

At the third step for generating a digital surface model, initial values for a digital surface model may be generated at step S330 by converting the 3D point cloud into a digital surface model form.

Here, at step S330, first, the ground surface in which the 3D point cloud is present may be divided into 2D grid cells.

Then, at step S330, a height that minimizes the following cost function, Cost_{height}(x, y), may be calculated by receiving the 3D point cloud, passing through noise filtering in each of the 2D grid cells, as input.

Cost_{height}(x,y)=Cost_{data}(x,y)+λ*Cost_{consistency}(x,y) (1)

In Equation (1), Cost_{data} may be a cost function which is calculated by using the whole heights of 3D points included in the 2D grid cell. In order to implement this function, various methods may be applied, and the function may be calculated using distances of the 3D points (heights) from the median value of the heights of the 3d points.

In Equation (1), Cost_{consistency} may be a cost function caused by the difference between the height of the 2D grid cell, which is intended to be calculated, and the height of a 2D grid cell adjacent thereto.

In order to implement this, various methods may be applied, and the function may be alternatively calculated as the sum of the differences between the currently estimated height of a 2D grid cell and heights of 2D grid cells adjacent thereto.

In Equation (1), (x, y) may be the ground surface coordinate index of the corresponding 2D grid cell.

The fourth step for generating a digital surface model is the step (S340) of filling a hole area such that the height of a 2D grid cell in which 3D points, based on which the height is calculated, are not present is estimated using information of the adjacent areas. Hereinafter, compensation of a hole area has, the same meaning as the above-mentioned hole-filling.

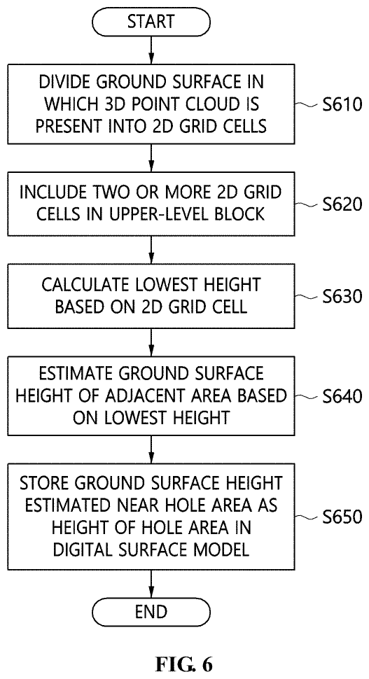

Here, at step S340, the hole area having no height information is compensated by estimating the height thereof using the heights of neighboring areas, and this step will be described with reference to FIGS. 6 to 8C.

Also, at the step of generating a digital surface model, additional noise filtering, a smoothing process, such as bilateral filtering, and the like may be additionally performed after completion of all of the above-described four steps or during the course of the above-described four steps.

FIG. 4 is a flowchart illustrating removal of noise according to an embodiment of the present invention, and FIGS. 5A, 5B and 5C are exemplary views illustrating removal of noise according to an embodiment of the present invention.

Referring to FIG. 4 and FIGS. 5A to 5C, in the method of removing noise, a height histogram may be calculated by receiving a 3D point cloud as input at step S430.

Also, in the method of removing noise, the height having the maximum density in the height histogram is regarded as a ‘reference height’ (h_{ground}) at step S440, and a height range within a predefined range (h_{range}) from the reference height may be regarded as a ‘ground surface height area’ at step S450.

Also, in the method of removing noise, the 3D space for which a digital surface model is to be generated is segmented into regularly spaced 3D voxel areas at step S410, and the number of 3D points included in each of the 3D voxel areas may be calculated.

Also, in the method of removing noise, starting from each of the 3D voxel areas, corresponding to the ground surface height area and including a number of 3D points equal to or greater than a preset number (min_pn), 3D voxel areas adjacent thereto may be sequentially checked at step S460.

Here, the 3D voxel area including 3D points, the number of which is equal to or greater than the preset number, may be marked as a valid terrain data candidate area.

Also, in the method of removing noise, the above-described process of checking 3D voxel areas adjacent to the newly marked 3D voxel area may be repeated.

Also, in the method of removing noise, 3D points in the 3D voxel area that is not eventually marked are determined to be a suspended mass in the sky, rather than being connected from the ground surface, that is, are regarded as noise, so may be removed at once at step S470.

Referring to FIGS. 5A to 5C, FIG. 5A illustrates a 3D point cloud before the above-mentioned noise is removed, FIG. 5B illustrates the process of marking a 3D voxel area connected from the above-described ground surface height area, and FIG. 5C illustrates the resultant 3D point cloud after removal of noise.

FIG. 6 is a flowchart illustrating compensation of a hole area according to an embodiment of the present invention.

Referring to FIG. 6, first, small hole areas fragmentarily generated with salt-and-pepper distribution may be processed by diffusing the height of a neighboring area by applying a morphology operation.

Here, the hole area in the shape of a dump, remaining after the above-described process, is regarded as a hole area caused due to the effect of occlusion in the vicinity of high-rise structures, a shadow effect, or the like, and may be processed by filling the height thereof by estimating the ground surface height of the neighboring area.

Here, the method of estimating a ground surface height is configured to divide the ground surface in which a 3D point cloud is present into 2D grid cells, as described above, at step S610, to group the 2D grid cells into upper-level blocks, each of which is to a unit larger than a 2D grid cell, at step S620, and to calculate the lowest height by aggregating valid heights in each of the upper-level blocks at step S630.

Also, in the method of estimating a ground surface height, ground surface heights are estimated in all of the 2D grid cells through an interpolation method, in which a ground surface height is estimated by connecting the lowest heights of adjacent upper-level blocks, at step S640, and when the corresponding 2D grid cell is a hole area, the estimated ground surface height may be stored as the height thereof in the digital surface model at step S650.

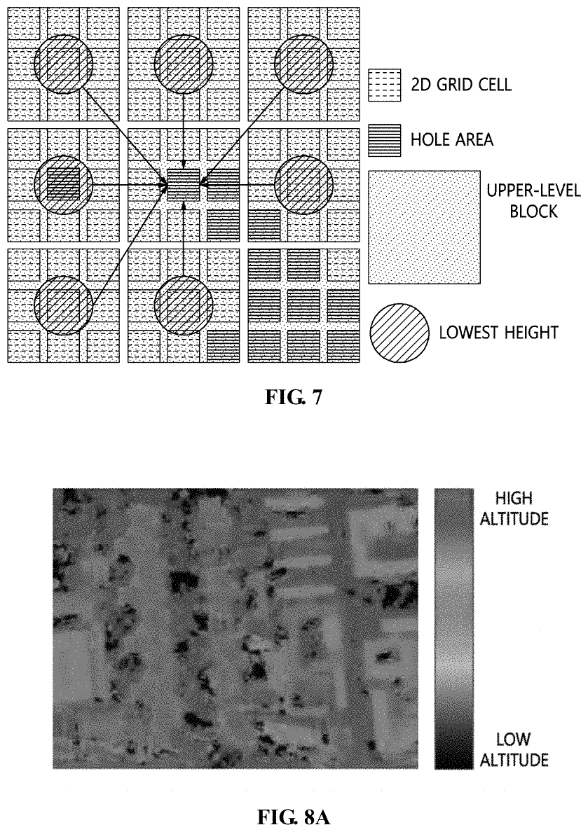

FIG. 7 is a concept diagram of the process of filling a hole area according to an embodiment of the present invention.

FIG. 7 is a concept diagram illustrating the process of filling or compensating the above-described hole area. Describing this process with reference to FIG. 7, a 2D grid cell represented as a rectangle filled with horizontal dotted lines is a unit for which each height is stored in a digital surface model, and a hole area, represented as a rectangle filled with dense horizontal lines, may be a hole area having no valid 3D point.

An upper-level block represented as a rectangular area filled with sparse small dots is an area segmented for calculating the lowest height therein, and a lowest height, represented as a translucent circle filled with diagonal lines, may be the lowest height in each upper-level block.

Here, when the hole areas, among the 2D grid cells included in an upper-level block, account for a certain percentage of the upper-level block, the lowest height of the corresponding upper-level block may not be calculated.

Here, the valid lowest heights of the upper-level blocks adjacent to the hole area are collected, the ground surface height of the current hole area is estimated using an interpolation method, which reflects the distance to the center position of the upper-level block including the lowest height, and the estimated ground surface height is stored as the height of the hole area. In this way, the heights of all of the hole areas may be stored.

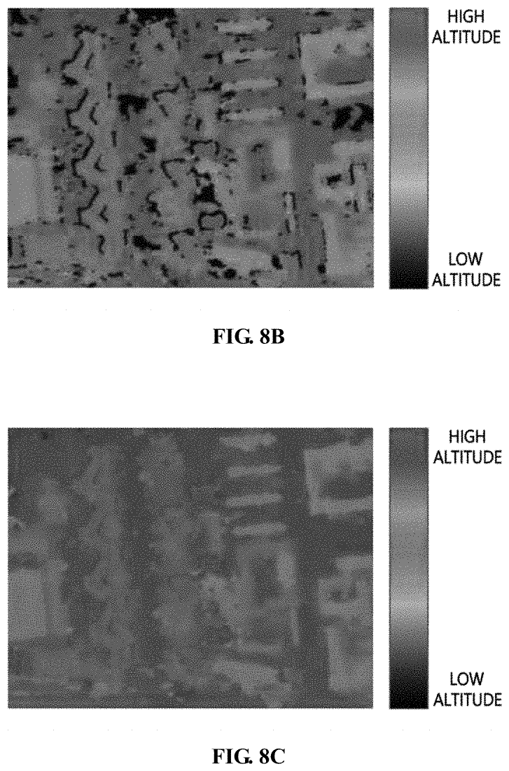

FIGS. 8A to 8C are comparison views illustrating noise removal and hole-filling according to an embodiment of the present invention.

Referring to FIGS. 8A to 8C, FIG. 8A illustrates a digital surface model that is generated by selecting a median height in the 3D point cloud converted from depth maps without applying any of noise removal and hole-filling. FIG. 8B illustrates the result acquired when only noise removal is applied without application of hole-filling, and it can be seen that a hole area (dark area) is formed near high-rise buildings.

FIG. 8C illustrates a digital surface model to which both noise removal and hole-filling are applied, and it can be seen that the noise shown in FIG. 8A disappears and that the shape of the building is preserved by filling the hole area.

Hereinafter, a method for generating a digital surface model using satellite imagery according to an embodiment of the present invention will be described with reference to FIGS. 1 to 4 and FIG. 6.

In the method for generating a digital surface model using satellite imagery according to an embodiment of the present invention, a geometric error in input satellite images is corrected at step S110.

Here, the satellite images may include geometric or optical information pertaining to the camera that was used to capture the satellite images by storing the same as Rational Polynomial Coefficients (RPC).

Here, at step S110, the geometric error may be corrected using at least one of a method of comparing the satellite images with Ground Control Point (GCP) data and a method of comparing the satellite images with orthogonal projection data of a Digital Elevation Model (DEM).

Also, in the method for generating a digital surface model using satellite imagery according to an embodiment of the present invention, one or more depth maps are generated using a stereo matching method based on the corrected satellite images at step S120.

Here, step S120 may include resampling the epipolar lines of the satellite images by converting the epipolar lines in units of pixels such that the epipolar lines become straight lines at step S210, arranging the satellite images to be grouped in pairs at step S220, and generating depth maps using a stereo matching method based on the arranged satellite images at step S230.

Also, in the method for generating a digital surface model using satellite imagery according to an embodiment of the present invention, the generated depth maps are combined, and a height for each location on the ground surface is estimated, whereby a digital surface model is generated at step S130.

Here, step S130 may include generating a 3D point cloud based on the depth maps at step S310, removing noise from the 3D point cloud at step S320, generating initial values for a digital surface model based on the 3D point cloud from which noise is removed at step S330, and compensating a hole area in which the 3D point cloud is not included at step S340.

Here, step S310 may include converting the depth values of the respective pixel in each depth map into 3D points in a geodetic coordinate system and generating a 3D point cloud by combining the 3D points.

Here, step S320 may include dividing the space of the 3D point cloud into regularly spaced 3D voxel areas at step S410, calculating the number of 3D points included in each of the 3D voxel areas at step S420, determining the 3D voxel area to be a valid area when the number of 3D points included therein is equal to or greater than a preset reference number or determining the 3D voxel area to be noise when the number of 3D points included therein is less than the preset reference number at step S460, and removing 3D points included in the 3D voxel area determined to be noise at step S470.

Also, step S320 may further include calculating a height histogram based on the 3D point cloud at step S430, setting a height having the maximum density in the height histogram as a reference height at step S440, and setting a height range within a preset constant range from the reference height as a ground surface height area at step S450.

Here, at step S460, the 3D voxel area including a number of 3D points equal to or greater than the preset reference number while being included in the ground surface height area is determined to be the valid area, and whether a 3D voxel area is a valid area may be sequentially checked from the 3D voxel areas adjacent thereto.

Here, step S340 may include dividing a ground surface in which the 3D point cloud is present into 2D grid cells at step S610, grouping the 2D grid cells into upper-level blocks such that each of the upper-blocks includes two or more 2D grid cells at step S620, calculating a lowest height based on the 2D grid cells having a valid height in each of the upper-level blocks at step S630, estimating a ground surface height in an adjacent area based on the lowest height of each of the upper-level blocks at step S640, and storing the ground surface height estimated in the vicinity of a hole area as the height of the hole area in the digital surface model at step S650.

Also, step S340 may further include noise filtering, which includes at least one of bilateral filtering and a smoothing process.

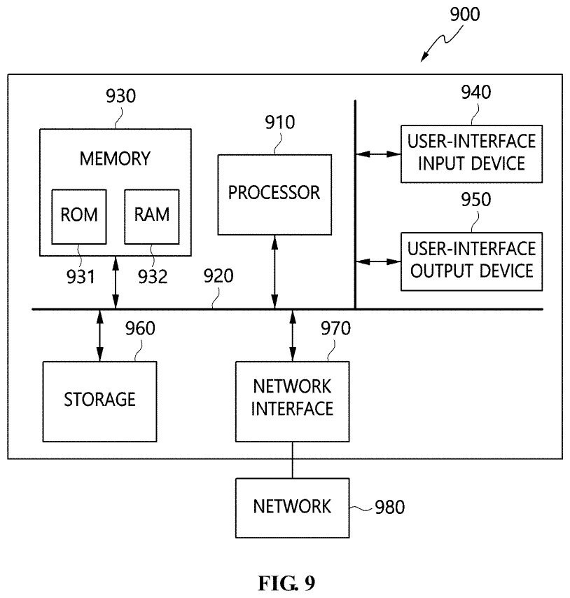

FIG. 9 is a view illustrating a computer system according to an embodiment of the present invention.

Referring to FIG. 9, an embodiment of the present invention may be implemented in a computer system including a computer-readable recording medium. As illustrated in FIG. 9, the computer system 900 may include one or more processors 910, memory 930, a user-interface input device 940, a user-interface output device 950, and storage 960, which communicate with each other via a bus 920. Also, the computer system 900 may further include a network interface 970 connected to a network 980. The processor 910 may be a central processing unit or a semiconductor device for executing processing instructions stored in the memory 930 or the storage 960. The memory 930 and the storage 960 may be any of various types of volatile or nonvolatile storage media. For example, the memory may include ROM 931 or RAM 932.

An apparatus for generating a digital surface model using satellite imagery according to an embodiment of the present invention includes one or more processors and executable memory for storing at least one program executed by the one or more processors. The at least one program may correct a geometric error in input satellite images, generate one or more depth maps using a stereo matching method based on the corrected satellite images, combine the generated depth maps, and generate a digital surface model by estimating a height for each location on the ground surface.

Here, the satellite images may include geometric or optical information of a camera used to capture the satellite images by storing the same as Rational Polynomial Coefficients (RPC).

Here, the at least one program may correct the geometric error using at least one of a method of comparing the satellite images with Ground Control Point (GCP) data and a method of comparing the satellite images with orthogonal projection data of a Digital Elevation Model (DEM).

Here, the at least one program may resample the epipolar lines of the satellite images by converting the epipolar lines in units of pixels such that the epipolar lines become straight lines, may arrange the satellite images to be grouped in pairs, and may generate depth maps using a stereo matching method based on the arranged satellite images.

Here, the at least one program may generate a 3D point cloud based on the depth maps, remove noise from the 3D point cloud, generate initial values for a digital surface model based on the 3D point cloud from which noise is removed, and compensate a hole area in which the 3D point cloud is not included.

Here, the at least one program may convert the depth values of the respective pixels in the depth map into 3D points in a geodetic coordinate system, and may generate a 3D point cloud by combining the 3D points.

Here, the at least one program may divide the space of the 3D point cloud into regularly spaced 3D voxel areas, calculate the number of 3D points included in each of the 3D voxel areas, determine that a 3D voxel area is a valid area when the number of 3D points included therein is equal to or greater than a preset reference number, determine that a 3D voxel area is noise when the number of 3D points included therein is less than the present reference number, and remove the 3D points included in the 3D voxel area determined to be noise, thereby removing the noise.

Here, the at least one program may calculate a height histogram based on the 3D point cloud, set a height having the maximum density in the height histogram as a reference height, set a height range within a preset constant range from the reference height as a ground surface height area, determine a 3D voxel area including a number of 3D points equal to or greater than the preset reference number while being included in the ground surface height area to be a valid area, and sequentially determine whether a 3D voxel area is a valid area from the area adjacent to the valid area.

Here, the at least one program may divide a ground surface in which the 3D point cloud is present into 2D grid cells, put the 2D grid cells into upper-level blocks such that each of the upper-level blocks includes two or more 2D grid cells, calculate the lowest height based on 2D grid cells having a valid height in each of the upper-level blocks, estimate a ground surface height of an adjacent area based on the lowest height of each of the upper-level blocks, and store the ground surface height estimated in the vicinity of a hole area as the height of the hole area in the digital surface model, thereby compensating the hole area.

Here, the at least one program may perform noise filtering, including at least one of bilateral filtering and a smoothing process, and may compensate the hole area.

Accordingly, an embodiment of the present invention may be implemented as a nonvolatile computer-readable storage medium in which methods implemented using a computer or instructions executable in a computer are recorded. When the computer-readable instructions are executed by a processor, the computer-readable instructions may perform a method according to at least one aspect of the present invention.

According to the present invention, a digital surface model may be generated by receiving mono satellite images.

Also, according to the present invention, reduction of noise components may be realized using the characteristics of a space, and a method for effectively processing a hole area for which no spatial information is present may be provided.

The effects of the present embodiments are not limited to the above-mentioned effects, and other unmentioned effects will be clearly understood from the following claims by those having ordinary skill in the technical field to which the present invention pertains.

As described above, the apparatus and method for generating a digital surface model using satellite imagery according to the present invention are not limitedly applied to the configurations and operations of the above-described embodiments, but all or some of the embodiments may be selectively combined and configured, so the embodiments may be modified in various ways.

What is claimed is:

1. A method for generating a digital surface model using satellite imagery, comprising:
correcting a geometric error in input satellite images;
generating one or more depth maps using a stereo matching method based on the satellite images, the geometric error of which is corrected;
combining the generated depth maps and estimating a height for each location on a ground surface, thereby generating a digital surface model.

2. The method of claim 1, wherein the satellite images include geometric or optical information pertaining to a camera that is used to capture the satellite images, the geometric or optical information being stored as Rational Polynomial Coefficients (RPC).

3. The method of claim 1, wherein correcting the geometric error is configured to correct the geometric error using at least one of a method of comparing the satellite images with Ground Control Point (GCP) data and a method of comparing the satellite images with orthogonal projection data of a Digital Elevation Model (DEM).

4. The method of claim 1, wherein generating the depth maps comprises:
resampling epipolar lines of the satellite images by converting the epipolar lines in units of pixels such that the epipolar lines become straight lines;
arranging the satellite images to be grouped in pairs; and
generating the depth maps using the stereo matching method based on the arranged satellite images.

5. The method of claim 1, wherein generating the digital surface model comprises:
generating a 3D point cloud based on the depth maps;
removing noise from the 3D point cloud;
generating initial values for the digital surface model based on the 3D point cloud from which the noise is removed; and
compensating a hole area in which the 3D point cloud is not included.

6. The method of claim 5, wherein generating the 3D point cloud comprises:
converting depth values of respective pixels in each of the depth maps into 3D points in a geodetic coordinate system; and
generating the 3D point cloud by combining the 3D points.

7. The method of claim 5, wherein removing the noise comprises:
dividing a space of the 3D point cloud into regularly spaced 3D voxel areas;
calculating a number of 3D points included in each of the 3D voxel areas;
determining a 3D voxel area to be a valid area when the number of 3D points included therein is equal to or greater than a preset reference number or determining the 3D voxel area to be noise when the number of 3D points included therein is less than the preset reference number; and
removing the 3D points included in the 3D voxel area determined to be the noise.

8. The method of claim 7, further comprising:
calculating a height histogram based on the 3D point cloud;
setting a height having a maximum density in the height histogram as a reference height; and
setting a height range within a preset constant range from the reference height as a ground surface height area,
wherein determining the 3D voxel area is configured to determine a 3D voxel area including a number of 3D points equal to or greater than the preset reference number while being included in the ground surface height area to be a valid area and to then sequentially determine 3D voxel areas adjacent to the valid area.

9. The method of claim 5, wherein compensating the hole area comprises:
dividing a ground surface in which the 3D point cloud is present into 2D grid cells;
grouping the 2D grid cells into upper-level blocks such that each of the upper-level blocks includes two or more 2D grid cells;
calculating a lowest height based on 2D grid cells having a valid height in each of the upper-level blocks;
estimating a ground surface height of an adjacent area based on the lowest height of each of the upper-level blocks; and
storing the ground surface height estimated near the hole area as a height of the hole area in the digital surface model.

10. The method of claim 9, wherein compensating the hole area further comprises:
performing noise filtering including at least one of bilateral filtering and a smoothing process.

11. An apparatus for generating a digital surface model using satellite imagery, comprising:
one or more processors; and
executable memory for storing at least one program executed by the one or more processors,
wherein the at least one program is configured to
correct a geometric error in input satellite images,
generate one or more depth maps using a stereo matching method based on the satellite images, the geometric error of which is corrected,
combine the generated depth maps,
estimate a height for each location on a ground surface, and
generate a digital surface model.

12. The apparatus of claim 11, wherein the satellite images include geometric or optical information pertaining to a camera that is used to capture the satellite images, the geometric or optical information being stored as Rational Polynomial Coefficients (RPC).

13. The apparatus of claim 11, wherein the at least one program is configured to correct the geometric error using at least one of a method of comparing the satellite images with Ground Control Point (GCP) data and a method of comparing the satellite images with orthogonal projection data of a Digital Elevation Model (DEM).

14. The apparatus of claim 11, wherein the at least one program is configured to:
resample epipolar lines of the satellite images by converting the epipolar lines in units of pixels such that the epipolar lines become straight lines,
arrange the satellite images to be grouped in pairs, and
generate the depth maps using the stereo matching method based on the arranged satellite images.

15. The apparatus of claim 11, wherein the at least one program is configured to:
generate a 3D point cloud based on the depth maps,
remove noise from the 3D point cloud,
generate initial values for the digital surface model based on the 3D point cloud from which the noise is removed, and
compensate a hole area in which the 3D point cloud is not included.

16. The apparatus of claim 15, wherein the at least one program is configured to:
convert depth values of respective pixels in each of the depth maps into 3D points in a geodetic coordinate system, and
generate the 3D point cloud by combining the 3D points.

17. The apparatus of claim 15, wherein the at least one program is configured to remove the noise by dividing a space of the 3D point cloud into regularly spaced 3D voxel areas, calculating a number of 3D points included in each of the 3D voxel areas, determining a 3D voxel area to be a valid area when the number of 3D points included therein is equal to or greater than a preset reference number, determining the 3D voxel area to be noise when the number of 3D points included therein is less than the preset reference number, and removing the 3D points included in the 3D voxel area determined to be the noise.

18. The apparatus of claim 17, wherein the at least one program is configured to:
calculate a height histogram based on the 3D point cloud,
set a height having a maximum density in the height histogram as a reference height,
set a height range within a preset constant range from the reference height as a ground surface height area,
determine a 3D voxel area including a number of 3D points equal to or greater than the preset reference number while being included in the ground surface height area to be a valid area, and
sequentially determine whether a 3D voxel area is a valid area from a 3D voxel area adjacent to the valid area.

19. The apparatus of claim 15, wherein the at least one program is configured to compensate the hole area by dividing a ground surface in which the 3D point cloud is present into 2D grid cells, grouping the 2D grid cells into upper-level blocks such that each of the upper-level blocks includes two or more 2D grid cells, calculating a lowest height based on 2D grid cells having a valid height in each of the upper-level blocks, estimating a ground surface height of an adjacent area based on the lowest height of each of the upper-level blocks, and storing the ground surface height estimated near the hole area as a height of the hole area in the digital surface model.

20. The apparatus of claim 19, wherein the at least one program is configured to compensate the hole area after performing noise filtering including at least one of bilateral filtering and a smoothing process.
